(19) United States
(12) Patent Application Publication
(10) Pub. No.: US 2004/0128351 A1
(43) Pub. Date: Jul. 1, 2004

(54) Mechanism to broadcast transactions to multiple agents in a multi-node system

(75) Inventors: Robert J. Hoogland, Portland, OR (US); Lily P. Looi, Portland, OR (US); Tuan M. Quach, Fullerton, CA (US); Kai Cheng, Portland, OR (US)

Correspondence Address: Pillsbury Winthrop LLP, Intellectual Property Group, 725 South Figueroa Street, Suite 2800, Los Angeles, CA, 90017-5406, US

(73) Assignee: Intel Corporation, Santa Clara, CA (US)

(21) Appl. No.: 10/330,612

(22) Filed: Dec. 27, 2002

(51) Int. Cl. G06F 15/173; G06F 15/16

(52) U.S. Cl. 709/204; 709/238

(57) ABSTRACT

In a multi-node computing system, the originating receiving device receives a broadcast request, decodes the broadcast request, and transmits a broadcast header to a primary tagging device. The primary tagging device generates at least one tagged broadcast header and transmits the at least one tagged broadcast header to the originating receiving device. The originating receiving device transmits tagged broadcast transaction(s) to broadcast receiving device(s). The broadcast receiving device(s) transmits the tagged broadcast transaction(s) to a broadcast node(s). The broadcast node(s) transmits a node completion signal(s) to the broadcast receiving device(s). The broadcast receiving device(s) transmits all of the node completion signal(s) to the primary tagging device. The primary tagging device transmits a transaction completion signal to the originating receiving device.

### BACKGROUND

1. Technical Field

This invention relates generally to transmitting transactions in a multi-node system, and, more specifically, to transmitting broadcast transactions to multiple nodes in a multi-node system.

2. Discussion of the Related Art

In multi-node systems that may include multiple processors, there are some transactions that may need to be sent out to all processors and other agents within the system. Examples of these types of transactions include broadcast interrupts, end of interrupt messages, and purge translation cache cache requests. Unlike single-shared processor bus systems where all processors automatically see the transaction, multiple processor systems with separate or unique processor buses may not see these transactions, unless the transactions are sent out to all nodes in a multi-node system. The transmitting of transactions to all nodes is not very efficient because many nodes that will not utilize the transaction may receive the transaction.

### BRIEF DESCRIPTION OF THE DRAWINGS

FIG. 1 (a) illustrates coupling of nodes in a multi-node computing system;

FIG. 1 (b) illustrates transmission of a broadcast transaction in a multi-node computing system according to an embodiment of the present invention;

FIG. 2 illustrates a switching device and a first portion of broadcast transaction according to an embodiment of the present invention;

FIG. 3 illustrates a second portion of the exemplary broadcast transaction of the present invention; and

FIG. 4 illustrates a flowchart describing the flow of a broadcast transaction in a multi-node computing system according to an embodiment of the present invention;

FIG. 5 illustrates a path of an interrupt broadcast transaction and a purge translation cache broadcast transaction according to an embodiment of the present invention;

FIG. 6 illustrates a path of an end interrupt broadcast transaction according to an embodiment of the present invention;

FIG. 7 illustrates a path of a lock broadcast transaction according to an embodiment of the present invention; and

FIG. 8 illustrates a path of a writeback broadcast transaction according to an embodiment of the present invention.

### DETAILED DESCRIPTION

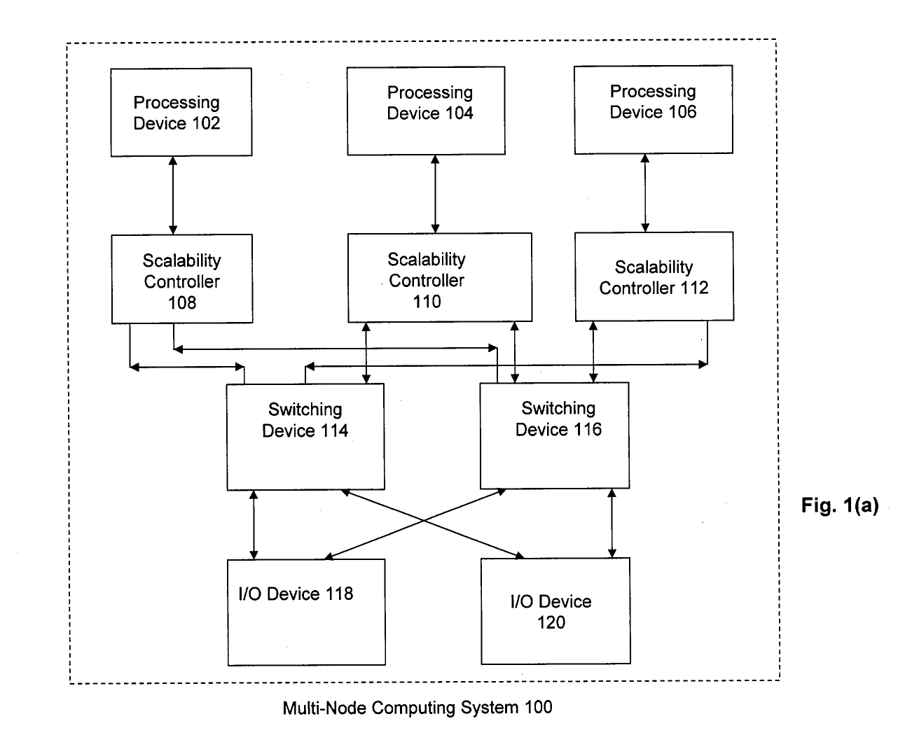

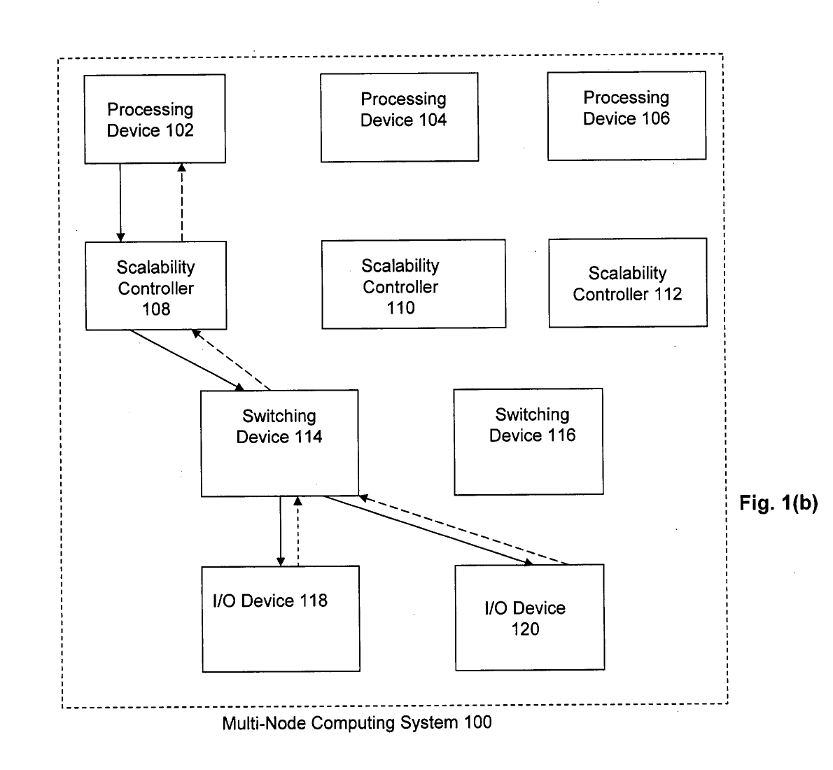

In an embodiment of the present invention, an originating node in a multi-node computing system transmits broadcasts transactions to at least one broadcast node of a plurality of nodes through a switching device. FIG. 1 (a) illustrates the coupling of nodes in a multi-node computing system. FIG. 1 (b) illustrates a node transmitting a broadcast transaction to at least one broadcast node according to an embodiment of the present invention. As illustrated in FIG. 1 (a), the multi-node computing system 100 may include multiple processors, as illustrated by processors 102, 104, and 106 in FIG. 1 (a). In an embodiment of the present invention, sixteen processors may be included in the multi-node computer system 100. In an embodiment of the present invention, multiple processors may be coupled to a scalability controller. The multi-node computing system 100 may be a physical server, a mainframe computer, a logical server, i.e., multiple physical devices that make up a single server.

The multi-node computing system 100 may include at least one processor 102, 104, and 106, at least one scalability controller 108, 110, and 112, at least one switching device 114 and 116, and at least one input/output (I/O) device 118 and 120. The coupling of the nodes, i.e., processors, scalability controllers, switching devices, and I/O devices, is illustrated in FIG. 1 (a). In one embodiment of the present invention, the switching device, for example, switching device 114, may be integrated into a scalability controller, for example, scalability controller 108. In an alternative embodiment of the present invention, the switching device 114 may be integrated into a processor device, for example processor device 102

Broadcast transactions may be issued from an originating node, i.e., the at least one processing device 102, 104, and 106, the at least one scalability controller 108, 110, and 112, or the at least one input/output device 118 and 120, and may need to be broadcast to at least one broadcast node in the plurality of nodes, i.e, switching devices, processing devices, scalability controllers, etc. In embodiments of the present invention, the broadcast transaction may be transmitted back to the originating node that originally sent the broadcast transaction.

In an embodiment of the present invention, one of the switching devices 114 and 116 may receive a request to broadcast a transaction to at least one broadcast node of the plurality of nodes in the multi-node computing system 100. For simplicity, only one of the switching devices will be discussed. The switching device 114 may receive the broadcast transaction request from an originating node. In an embodiment of the present invention, the switching device 114 may determine the number of nodes to which the broadcast transaction should be transmitted, i.e., may determine the number of at least one broadcast nodes, and may generate a corresponding number of tagged broadcast transactions. In this embodiment of the present invention, the tagging may identify the node that is to receive the tagged broadcast transaction. The tagged broadcast transactions are then transmitted to the at least one broadcast nodes.

In this embodiment of the present invention, the broadcast nodes of the plurality of nodes of the multi-node computing system 100 may transmit a completion signal to the switching device 114 after the tagged broadcast transaction has been received at the broadcast node. In this embodiment of the invention, the switching device 114 may receive node completion signals from the at least one broadcast node to which the switching device 114 sent tagged broadcast transactions. After receiving all of the node completion signals from the at least one broadcast node(s), the switching device 114 may send a transaction completion signal to the originating node indicating that the broadcast transaction was successfully completed.

FIG. 1 (b) illustrates an end interrupt broadcast transaction according to an embodiment of the present invention. In this embodiment, the processing device 102 may be the originating node, i.e., the processing device 102 may originate the end interrupt broadcast transaction and transmit the end interrupt broadcast transaction to the switching device 114 through the scalability controller 108. Because the end interrupt broadcast transaction may be transmitted to I/O nodes 118 and 120, the switching device 114 may create two tagged broadcast transactions and may transmit the two tagged broadcast transactions to the broadcast nodes, in this embodiment the I/O devices 118 and 120. The two I/O devices 118 and 120 may each receive the tagged broadcast transactions and may each transmit a node completion signal to the switching device 114. Once the switching device 114 receives the node completion signals from I/O devices 118 and 120, the switching device 114 may transmit a transaction completion signal to the processing device 102, i.e., the originating node, through the scalability controller 108.

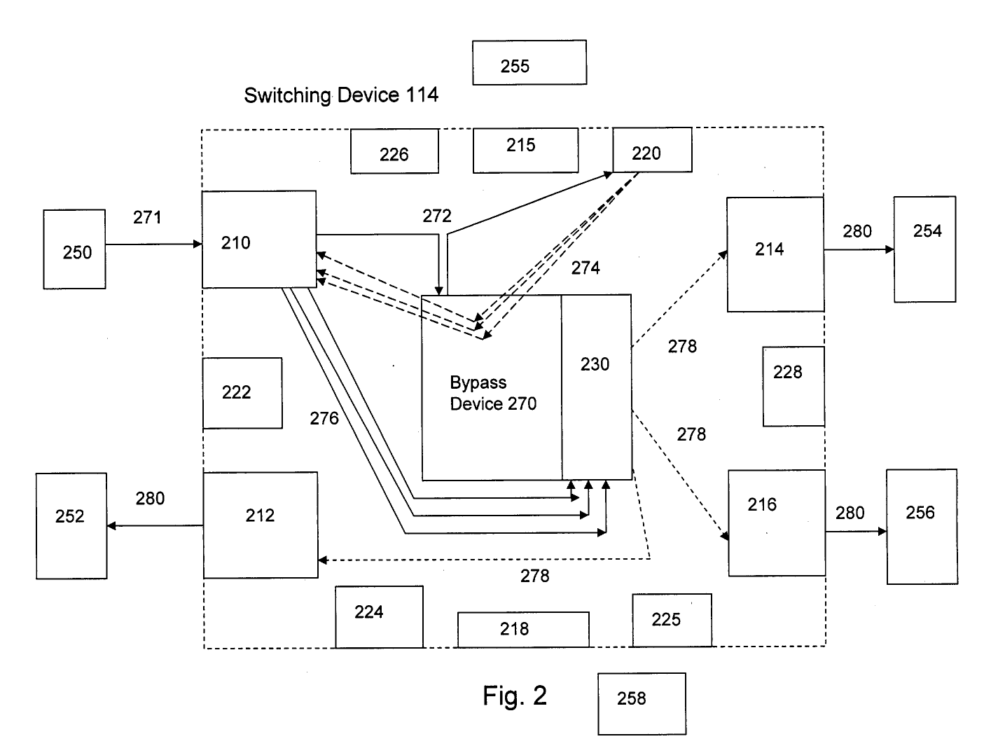

FIG. 2 illustrates a switching device and a first portion of broadcast transaction according to an embodiment of the present invention. The switching device 114 may include a plurality of receiving devices 210, 212, 214, 215, 216, and 218, including an originating receiving device, e.g., receiving device 210, and a plurality of tagging devices 220, 222, 224, 225, 226, and 228, including a primary tagging device, e.g., primary tagging device 220. In embodiments of the present invention, the number of the plurality of receiving devices may be different from the number of the plurality of tagging devices. For example, the number of receiving devices may be six and the number of receiving devices may be four. The originating receiving device 210 may receive a broadcast transaction from an originating node of the multi-node computing system 100, as illustrated by path 271 in FIG. 2. For example, the originating receiving device 210 in the switching device 114 may receive a broadcast transaction requesting the switching device 114 to send the broadcast transaction to all processor busses, i.e., to send a broadcast transaction to all receiving devices 210, 212, 214, 215, 216, and 218 that are coupled to processor devices 102, 104, and 106, either directly or indirectly. In some embodiments of the present invention, the broadcast transaction may be a packet that includes a broadcast header or may be a packet that includes a broadcast header and broadcast data.

In an embodiment of the present invention, the originating receiving device 210 may decode the broadcast transaction. The originating receiving device 210, in decoding the broadcast transaction, may separate the broadcast header of the broadcast transaction from the broadcast data of the broadcast transaction, in cases where the broadcast transaction includes the broadcast header and the broadcast data, or may extract the broadcast header, in cases where the broadcast transaction includes a broadcast header only. The originating receiving device 210 may transmit the broadcast header to a primary tagging device 220. In an embodiment of the present invention, the originating receiving device 210 may transmit the broadcast header to a bypass device 270 and the bypass device 270 may transmit the broadcast header to the primary tagging device 220. The bypass device 270 may be utilized to connect the plurality of receiving devices 210, 212, 214, 215, 216, and 218 to the primary tagging device 220. In an embodiment of the invention, the originating receiving device 210 may store the broadcast data of the broadcast transaction. Under certain operating conditions, the originating device 210 may store multiple copies of the broadcast data in a storage module in the originating receiving device 210.

The switching device 114 may include a plurality of tagging devices 220, 222, 224, 225, 226, and 228. In an embodiment of the present invention, one of the plurality of tagging devices 220, 222, 224, and 226 may be designated as the primary tagging device or the default tagging device. In this example, the primary tagging device may be 220. The plurality of tagging devices 220, 222, 224, 225, 226, and 228 may logically be a centralized unit. The actual physical implementation of the tagging devices 220, 222, 224, 225, 226, and 228 may split the tagging modules into interleaves, the interleaves each corresponding to one of the plurality of tagging modules 220, 222, 224, 225, 226, and 228. In an embodiment of the present invention, interleave 0 is the primary tagging device 220.

In an alternative embodiment of the present invention, the switching device 114 may be divided into two domain partitions. The two domain partitions of the switching device 114 may be running under two unique operating systems that are both installed on the multi-node computing system 100. The two domain partitions may not be physical partitions and may be logical partitions. Each of the plurality of domain partitions may include a primary tagging device (not shown). Thus, two versions, including two primary tagging devices of the present invention may be operating concurrently, without any interaction, in two logical domain partitions on one switching device 114.

The primary tagging device 220 may include a receiving device connection register (not shown). The receiving device connection register may identify which of the plurality of receiving devices are actively connected to one of the plurality nodes of the multi-node computing system. In an embodiment of the present invention, the receiving device connection register may receive information periodically by polling the receiving devices 210, 212, 214, 215, 216, and 218. Alternatively, the receiving device connection register may receive information from the receiving devices 210, 212, 214, 215, 216, and 218, i.e., the receiving devices 210, 212, 214, 215, 216, and 218 may transmit a connection signal when a node of the multi-node computing system is connected to the receiving device. The receiving device connection register may have information on the type of device that is coupled to the receiving device 210, 212, 214, 215, 216, and 218. For example, the receiving device connection register may identify that receiving devices 210, 212, and 214 are coupled to I/O devices, receiving devices 216 and 218 are coupled to processor devices, and that receiving device 215 is not active, i.e., not communicating with any device. In an embodiment of the invention, the receiving device connection register may be a REM_CDEF register.

The primary tagging device 220 may receive the broadcast header and may generate at least one tagged broadcast header. The actual number of tagged broadcast header(s) may correspond to the number of receiving device(s) 210, 212, 214, 215, 216, and 218 actively connected to the switching device 114 which are broadcast receiving devices of the plurality of receiving devices 210, 212, 214, 215, 216, and 218. For example, as illustrated in FIG. 2, if a purge translation cache broadcast transaction is designated to be sent to all processor/memory nodes through the scalability controllers, in FIG. 2 nodes 252, 254, and 256 are scalability controllers, and three of the receiving devices 212, 214, and 216 are actively connected to nodes 252, 254, and 256, then the three receiving devices 212, 214, and 216 are broadcast receiving devices. Thus, the primary tagging device may generate three broadcast headers, as illustrated by 274 in FIG. 2.

If the originating receiving device 210 is one of the plurality of receiving devices 210, 212, 214, 215, 216, and 218 actively connected to one of the nodes identified to receive the broadcast transaction, one less tagged broadcast header may be generated. Under other operating conditions, a tagged broadcast header may be generated for the originating receiving device 210.

The tagged broadcast header may include an address or identification of the node to receive the tagged broadcast transaction. In the example above, the tagged broadcast header may include identification that this tagged broadcast header should be transmitted to scalability controller/node 256, which is connected to receiving device 216.

In an embodiment of the invention, a last tagged broadcast header may be designated as a final broadcast header. This may allow the originating receiving device 210 to reallocate a storage module which may have been utilized to store one or more copies of the broadcast data. In this embodiment of the present invention, the designation of the last tagged broadcast header, the receipt of the last tagged broadcast header by the originating receiving device 210, and the combining of the at least one broadcast header with at least one copy of the broadcast data may allow the originating receiving device 210 to deallocate or release the storage module.

The default tagging device 220 may transmit the tagged broadcast header(s) to the originating receiving device 210, as illustrated by 274 in FIG. 2. In an embodiment of the invention, the default tagging device 220 may transmit the tagged broadcast header(s) to the bypass device 270 and the bypass device 270 may transmit the tagged broadcast header(s) to the originating receiving device 210. The originating receiving device 210 may utilize the information in the tagged broadcast header(s) to identify the at least one destination of the at least one tagged broadcast header(s), i.e., identify the at least one broadcast receiving device of the plurality of receiving devices 210, 212, 214, 215, 216, and 218. If the broadcast data was stored in the originating receiving device 210, a copy of the broadcast transaction data may be attached to each of the broadcast header(s) in originating receiving device 210. This combination, i.e., tagged broadcast header and broadcast data, may be referred to as a tagged broadcast transaction. When no broadcast data was stored in the originating receiving device 210, the tagged broadcast header may be the major portion of the at least one tagged broadcast transaction.

The originating receiving device 210 may transmit the at least one tagged broadcast transaction to each of the plurality of receiving devices 210, 212, 214, 215, 216, and 218 that are coupled to the identified nodes that are to receive the broadcast transaction. For example, as illustrated in FIG. 2, in an embodiment where receiving devices 212, 214, and 216 are coupled to processor nodes, and the broadcast transaction is to be transmitted to all processor nodes, the originating receiving device may transmit a tagged broadcast transaction to each receiving device 212, 214, and 216.

In an embodiment of the present invention, the originating receiving device 210 may not communicate directly with the other plurality of receiving devices, e.g., 212, 214, 215, 216, and 218. In this embodiment, a connection device 230 may allow coupling of the plurality of receiving devices 210, 212, 214, 215, 216, and 218 to one another. In an embodiment of the present invention, the connection device 230 may be referred to as a crossbar. Thus, the at least one tagged broadcast transaction may be transmitted from the originating receiving device 210 through the connection device 230 to the plurality of other receiving devices 212, 214, 215, 216, and 218 that are identified in the tagged portion of the tagged broadcast transaction to receive the tagged broadcast transaction. Illustratively, in the example described above illustrated in FIG. 2, the three tagged broadcast transactions may be transmitted from the originating receiving device 210 to the connection device 230, as illustrated by 276 in FIG. 2, and the connection device 230 may transmit the three tagged broadcast transaction to the at least one broadcast receiving devices 212, 214 and 216, as illustrated by 278 in FIG. 2. Each of the identified receiving devices 212, 214, and 216 may transmit the corresponding at least one tagged broadcast transaction to the broadcast node, in this case to the three nodes coupled to processors 102, 104, and 106, i.e., broadcast nodes 252, 254, and 256. In the above-mentioned example, the receiving devices 212, 214, and 216 may transmit the corresponding at least one broadcast transaction to the scalability controllers 252, 254, and 256.

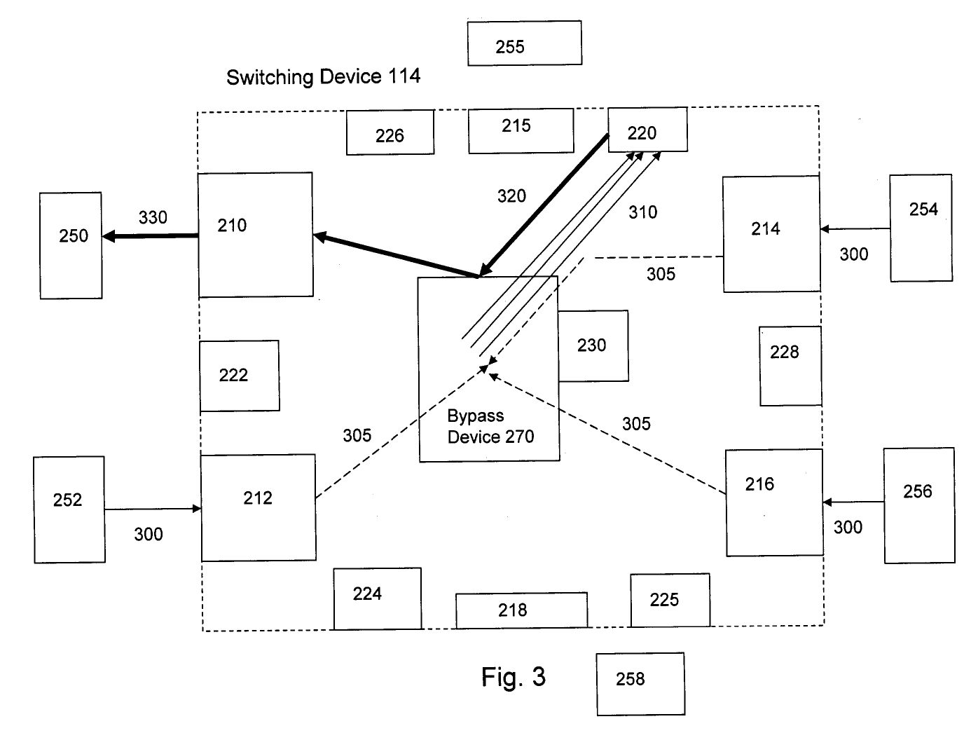

FIG. 3 illustrates a second portion of the exemplary broadcast transaction. Each of the at least one broadcast nodes of the plurality of nodes 250, 252, 254, 255, 256, and 258 may receive the tagged broadcast transaction from the receiving device 210, 212, 214, 215, 216, and 218 to which it is coupled. The at least one tagged broadcast transaction may instruct the at least one broadcast node of the plurality of nodes 250, 252, 254, 255, 256, and 258 to complete an action. Illustratively, the tagged broadcast transaction(s) may instruct the identified node 250, 252, 254, 255, 256, and 258 to purge the translation memory cache. Each of the broadcast node(s) of the plurality of nodes 250, 252, 254, 255, 256, and 258 may perform an action based on the instruction of the tagged broadcast transaction(s). When the action is completed, each of the at least one broadcast nodes may transmit a node completion signal to the switching device 114, or more specifically, the broadcast receiving device(s) of the plurality of receiving devices 210, 212, 214, 215, 216, and 218 to which the broadcast node(s) is coupled.

In the example discussed previously where three tagged broadcast transactions are transmitted through broadcast receiving devices 212, 214, and 216, as illustrated in FIG. 3, broadcast receiving device 212 corresponds to broadcast node 252, broadcast receiving device 214 corresponds to broadcast node 254, and broadcast receiving device 216 corresponds to broadcast node 256. Therefore, broadcast node 252, broadcast node 254, and broadcast node 256 may receive tagged broadcast transaction and perform the requested actions. Broadcast nodes 252,254, and 256 may each transmit a node completion signal to the switching device 114, or more specifically, the broadcast receiving devices 212, 214, and 216, respectively, as illustrated by 300 in FIG. 3.

The broadcast receiving device(s) of the plurality of receiving devices 210, 212, 214, 215, 216, and 218 may receive the node completion signal(s) from the broadcast node(s) of the plurality of nodes 250, 252, 254, 255, 256, and 258. The broadcast receiving device(s) of the plurality of receiving devices 210, 212, 214, 215, 216, and 218 may transmit node completion signal(s) to the bypass device 270. The bypass device 270 may receive the node completion signal(s) and may transmit the at least one node completion signal(s) to the default or primary tagging device 220. In the example illustrated in FIG. 3, nodes 252, 254, and 256 may each transmit the node completion signal to the broadcast receiving devices 212, 214, and 216, as illustrated by 300. The broadcast receiving device 212, 214, and 216 may transmit the three node completion signals to the bypass device 270, as illustrated by 305. The bypass device 270 may transmit the three node completion signals to the primary tagging device 220, as illustrated by 310.

Once the primary tagging device 220 receives all of the node completion signal(s) from the broadcast device(s) of the plurality of receiving devices 210, 212, 214, 215, 216, and 218 from the bypass device 270, the primary tagging device 220 may generate a transaction completion signal. The primary tagging device 220 may transmit the transaction completion signal to the bypass device 270. The bypass device 270 may receive the transaction completion signal from the primary tagging device 220. The bypass device 270 may transmit the transaction completion signal to the originating receiving device 210. The originating receiving device 210 may receive the transaction completion signal and may transmit the transaction completion signal to the originating node, i.e., the node that requested the broadcast transaction. In the example illustrated in FIG. 3, the bypass device 270 may receive the three node completion signals originating from broadcast nodes 252, 254, and 256, as illustrated by 305 and transmit the three node completions signals to the primary tagging device 220, as illustrated by 310. The primary tagging device 220 may generate a transaction completion signal once it has received all of the three node completion signals. The primary tagging device 220 may transmit the transaction completion signal through the bypass device 270 to the originating receiving device 210, as illustrated by 320. The originating receiving device 210 may receive the transaction completion signal and may transmit the transaction completion signal to the originating node 250, as illustrated by 330.

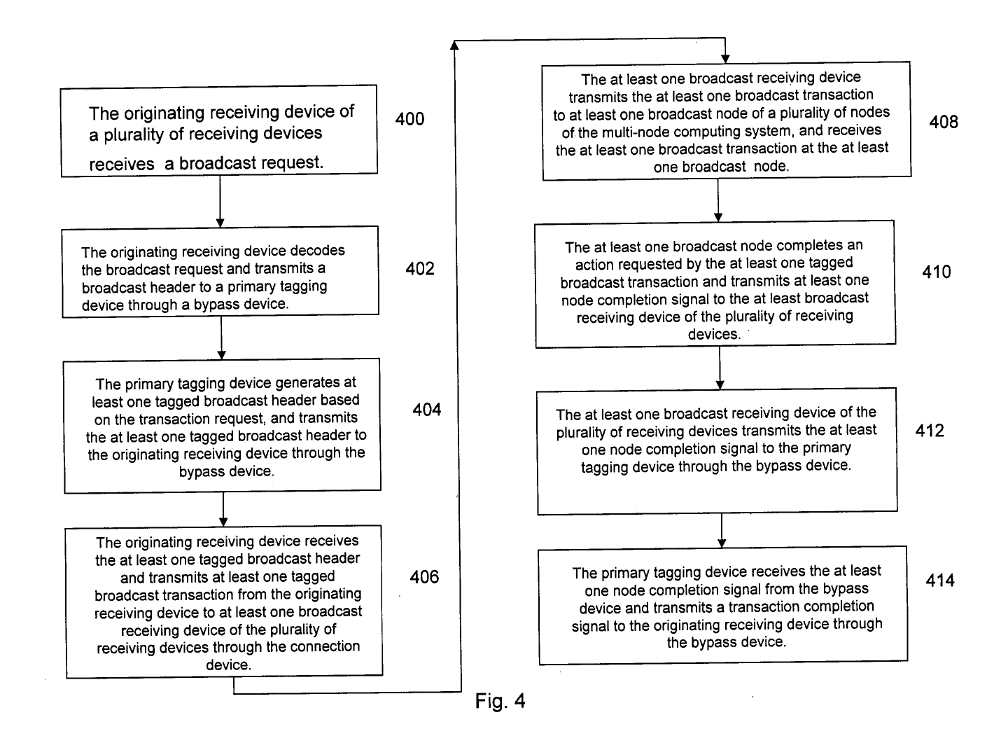

FIG. 4 illustrates a flowchart describing the flow of a broadcast transaction in a multi-node computing system according to an embodiment of the present invention. The originating receiving device of a plurality of receiving devices receives 400 a broadcast request. The originating receiving device decodes 402 the broadcast request and transmits a broadcast header to a primary tagging device through a bypass device. The primary tagging device generates 404 at least one tagged broadcast header based on the transaction request, and transmits the at least one tagged broadcast header to the originating receiving device through the bypass device. The originating receiving device receives 406 the at least one tagged broadcast header and transmits at least one tagged broadcast transaction from the originating receiving device to at least one broadcast receiving device of the plurality of receiving devices through the connection device. The at least one broadcast receiving device transmits 408 the at least one tagged broadcast transaction to at least one broadcast node of a plurality of nodes of the multi-node computing system. The at least one broadcast node completes 410 an action requested by the at least one tagged broadcast transaction and transmits at least one node completion signal to the at least one broadcast receiving device of the plurality of receiving devices. The at least one broadcast receiving device of the plurality of receiving devices transmits 412 the at least one node completion signal to the primary tagging device through the bypass device. The primary tagging device receives 414 all of the at least one node completion signal from the bypass device and transmits a transaction completion signal to the originating receiving device through the bypass device.

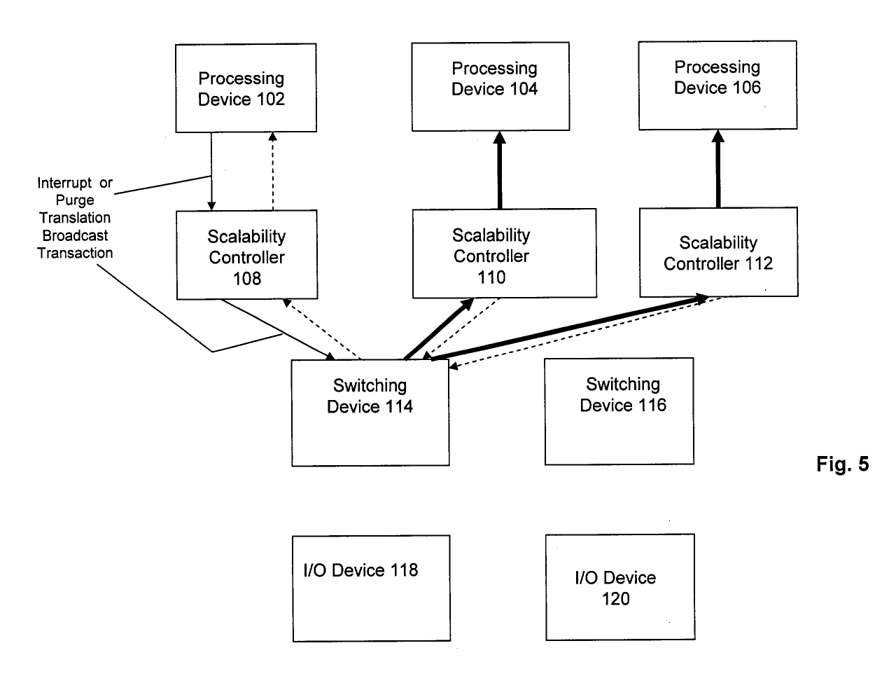

FIG. 5 illustrates a path of an interrupt broadcast transaction and a purge translation cache broadcast transaction according to an embodiment of the present invention. In an embodiment of the invention, a scalability controller 108, or a processor 102 through scalability controller 108, may send broadcast transactions to the switching device 114. Illustratively, the broadcast transactions may be interrupt broadcast transactions. In other embodiments of the present invention, the broadcast transaction may be a purge translation cache broadcast transaction. In some circumstances, the interrupt broadcast transactions may include data and in some circumstances, the interrupt broadcast transactions may not include data. The interrupt broadcast transactions may be xAPIC interrupts which are the inband interrupts used in Intel™ Pentium™ 4 compatible machines and future Intel™ microprocessor based products. Alternatively, the interrupt broadcast transactions may be SAPIC interrupts, which are the inband interrupts for Intel Architecture 32, 64 (IA32, IA64) or Itanium™ Processor Family (IPF) compatible machines. The interrupt broadcast transactions may be transmitted to all processors 102, 104, and 106, i.e., processors connected through scalability controllers 108, 110, and 112, connected to the switching device 114. Alternatively, the interrupt broadcast transaction may be transmitted to all processors except for the originating processor. In this operation condition, illustrated in FIG. 5, the interrupt broadcast transaction may be transmitted to processors 104 and 106 through the scalability controller devices 110 and 112 except for the scalability controller device 108 that transferred the interrupt broadcast transaction that originated from processing device 102. The scalability controllers 110 and 112 may transmit node completion signals to the switching device 114 and the switching device may transmit a transaction completion signal to the processing device 102 through the scalability controller 108.

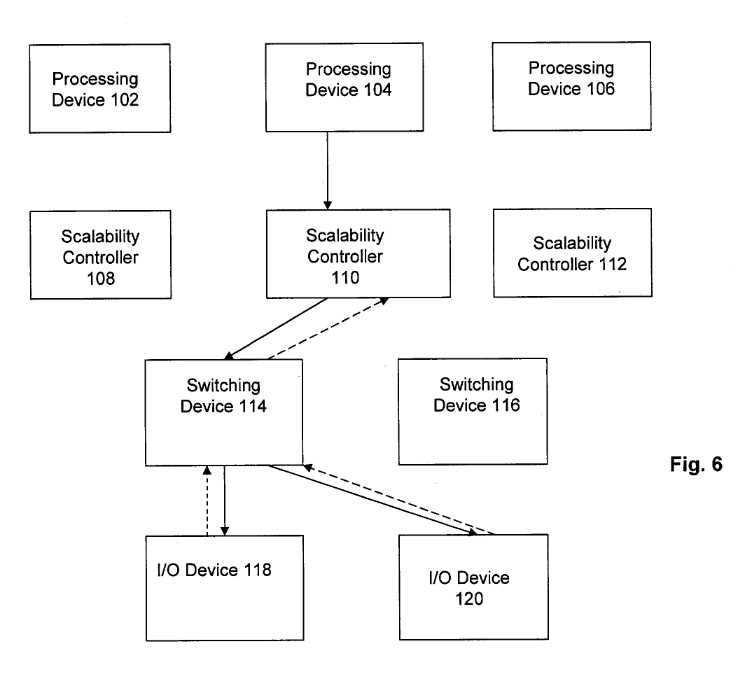

FIG. 6 illustrates a path of an end interrupt broadcast transaction according to an embodiment of the present invention. Broadcast transactions may be requested that are transmitted to I/O devices 118 and 120. A switching device 114 may transmit the end interrupt broadcast transactions to be transmitted to a plurality of I/O devices 118 and 120. Alternatively, an originating I/O device 120 may transmit an end interrupt broadcast transaction to the switching device 114 to be transmitted to a plurality of I/O devices 118 and 120. Alternatively, an originating scalability controller 110, or processor 104 through a scalability controller 110, may transmit an end interrupt broadcast transaction to the switching device 114 to be transmitted to a plurality of I/O devices 118 and 120, as illustrated by FIG. 6. In some circumstances the end interrupt broadcast transaction may include data and in some circumstances, the end interrupt broadcast transaction may not include data. As illustrated by FIG. 6, the I/O devices 118 and 129 transmit a node completion signal to the switching device 114. The switching device 114 may transmit an interrupt transaction to the processor 104 through the scalability controller 110.

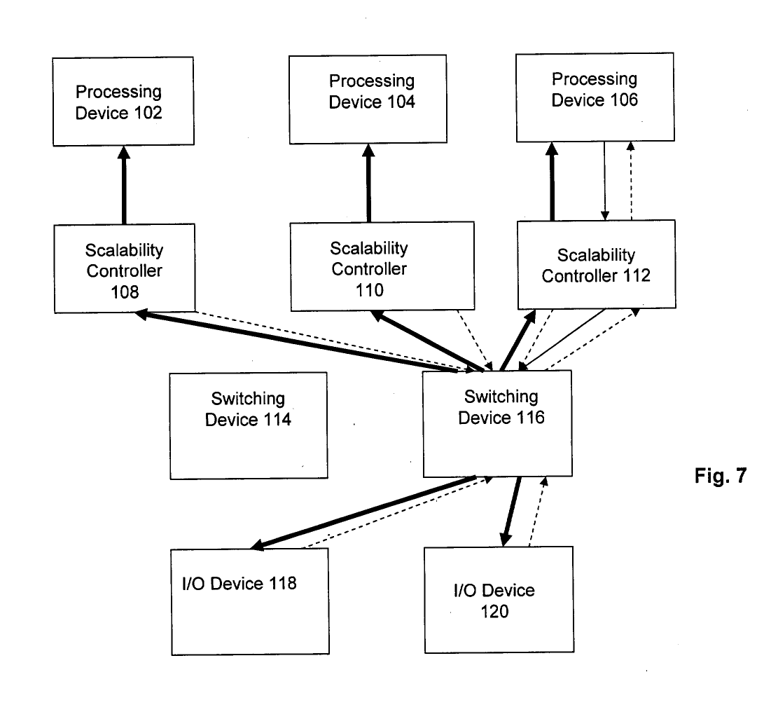

FIG. 7 illustrates a path of a lock broadcast transaction according to an embodiment of the present invention. Broadcast transactions may be requested that are transmitted to all devices, i.e., nodes connected to a switching device 116. A processor 106 may issue, or a scalability controller device 112 may issue a lock broadcast transaction. The lock broadcast transaction is designed to quiesce the system and prevent the mutli-node computing system from processing any other transactions until the atomic sequence is completed. The atomic sequence may be a read-write sequence. In embodiments where the read-write sequence is to uncacheable space, or if it spans more than one cacheline, the atomic sequence may appear as a locked read-write or a read-read-write-write sequence. As illustrated in FIG. 7, if two receiving devices, i.e., ports, are actively coupled to I/O devices 118 and 120, and three receiving devices, i.e., ports, are actively coupled to scalability controllers 108, 110, and 112, the lock broadcast transaction may be transmitted to both I/O agents 118 and 120 and the three scalability controllers 108, 110, and 112 through the receiving devices of the switching device 114 using the technique of the invention, which was described previously. The I/O devices 118 and 120 and the scalability controllers 108, 110, and 112 may transmit node completion signals to the switching device 116. The switching device upon receipt of all of the node completion signals from the I/O devices 118 and 120 and the scalability controllers 108, 110, and 112, may transmit a transaction completion signal to processor 106 through the scalability controller 112. After the atomic sequence is completed, in embodiments of the present invention, an unlock broadcast transaction may be transmitted to the locked nodes, i.e., I/O devices 118 and 120, and scalability controllers 108, 110, and 112. The unlock broadcast transaction may operate in the same manner as the lock broadcast transaction.

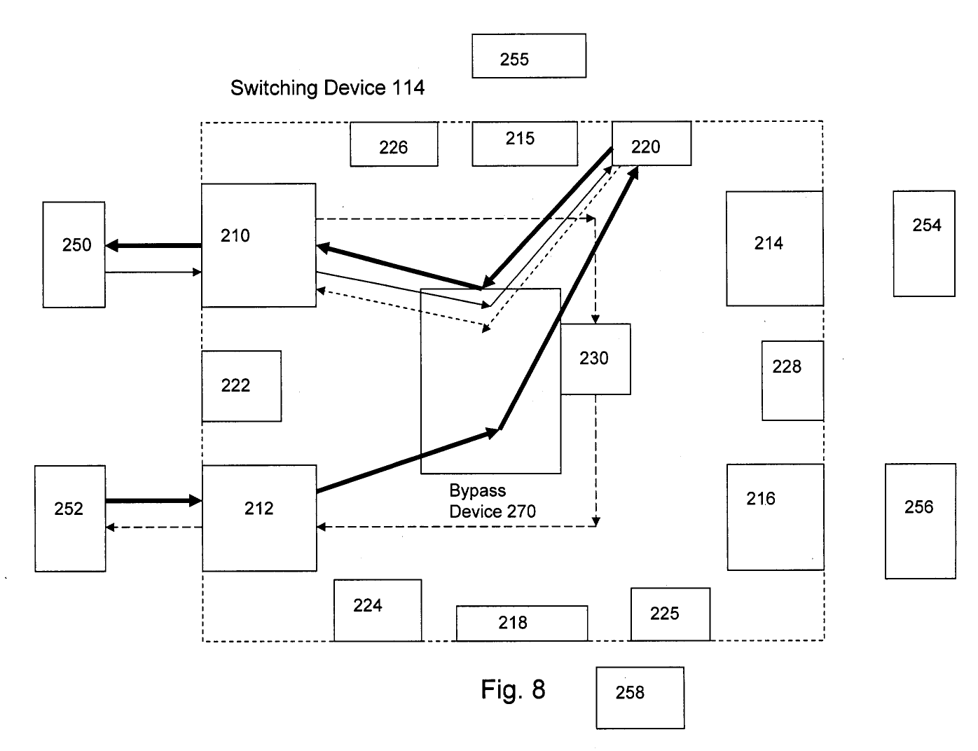

FIG. 8 illustrates a path of a writeback broadcast transaction according to an embodiment of the present invention. A processor may transmit a writeback broadcast transaction to the scalability controller 250 to which the processor may be coupled. The writeback broadcast transaction may be transmitted from the processor to the scalability controller 250 and then to the switching device 114. The originating receiving device 210 in the switching device 114 may receive the writeback broadcast transaction. The originating receiving device 210 may extract the header information from the writeback broadcast transaction and may transmit the writeback broadcast header to the bypass device 270 and on to the primary tagging device 220. In an embodiment of the present invention, the originating receiving device 210 may extract destination node information from the writeback broadcast transaction and pass that to the primary tagging device 220. The primary tagging device 220 may perform coherency and conflict checking for the writeback broadcast transaction. The primary tagging device 220 may not create multiple tagged headers because the writeback broadcast transaction may only be sent to one node, in this example node 252, which includes the memory where the writeback is being placed. The primary tagging device 220 may then transmit a tagged broadcast header to the originating receiving device 210 through the bypass device 270. The tagged broadcast header may be recombined with the data in the originating receiving device 210 to create a tagged writeback broadcast transaction. In one embodiment of the present invention, the tagged writeback broadcast transaction may not include data, i.e., a zero-length writeback.

The originating receiving device 210 may transmit the tagged writeback broadcast transaction to a destination node 252, where the tagged writeback broadcast transaction may be transmitted through the connection device 230 and the receiving device 212. In this embodiment of the invention, the destination node 252 may transmit a node completion signal to the receiving device 212 and the bypass device 270, indicating that the writeback has been performed. The bypass device 270 may transmit the node completion signal to the primary tagging device 220. The primary tagging device 220 may transmit a transaction completion signal to the originating node 250, where the transaction completion signal passes through the bypass device 270 and originating receiving device 210.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A switching device, comprising:
a plurality of receiving devices including an originating receiving device, wherein the originating receiving device receives a broadcast transaction, decodes the broadcast transaction, extracts a broadcast header, and transmits the broadcast header; and
a plurality of tagging devices including a primary tagging device, wherein the primary tagging device receives the broadcast header from the originating receiving device, generates at least one tagged broadcast header, and transmits the at least one tagged broadcast header to the originating receiving device.

2. The switching device of claim 1 wherein the originating receiving device receives the at least one tagged broadcast header and combines the at least one tagged broadcast header with a copy of broadcast data from the broadcast transaction to create a tagged broadcast transaction.

3. The switching device of claim 2, where at least one storage module in the receiving device is deallocated after reception of last tagged broadcast transaction and the at least one tagged broadcast header is combined with a copy of broadcast data.

4. The switching device of claim 1, further including a bypass device, wherein the bypass device receives the broadcast header from the originating receiving device, transmits the broadcast header to the primary tagging device, receives the at least one tagged broadcast header from the primary tagging device, and transmits the at least one tagged broadcast header to the originating receiving device.

5. The switching device of claim 4, further including a connecting device, wherein the originating receiving device receives the at least one tagged broadcast header from the bypass device, transmits at least one tagged broadcast transaction to the connecting device, and the connecting device transmits the at least one tagged broadcast transaction to at least one broadcast receiving device of the plurality of receiving devices.

6. The switching device of claim 5, further including a plurality of nodes, wherein the at least one broadcast receiving device of the plurality of receiving devices receives the at least one tagged broadcast transaction, transmits the at least one tagged broadcast transaction to at least one broadcast node of the plurality of nodes, and the at least one broadcast node receives the at least one tagged broadcast transaction.

7. The switching device of claim 6, wherein the at least one broadcast node completes an action requested by the at least one broadcast transaction, and transmits at least one node completion signal to the at least one broadcast receiving device of the plurality of receiving devices.

8. The switching device of claim 7, wherein the at least one broadcast receiving device transmits the at least one node completion signal to the bypass device and the bypass device transmits the at least one node completion signal to the primary tagging device.

9. The switching device of claim 8, wherein the primary tagging device, upon receipt of all of the at least one node completion signal from the at least one broadcast node through the at least one broadcast receiving device and the bypass device, transmits a transaction completion signal to the bypass device, and the bypass device transmits the transaction completion signal to the originating receiving device.

10. The switching device of claim 5, wherein the bypass device and the connecting device are included in a same physical device.

11. The switching device of claim 5, wherein the at least one tagged broadcast transaction includes broadcast data and a broadcast header.

12. A multi-node computing system, comprising
a plurality of nodes, including an originating node that generates a broadcast transaction; and
a switching device, including
a plurality of receiving devices including an originating receiving device, wherein the originating receiving device receives the broadcast transaction from the originating node, decodes the broadcast transaction, extracts a broadcast header, and transmits the broadcast header; and
a plurality of tagging devices including a primary tagging device, wherein the primary tagging device receives the broadcast header from the originating receiving device, generates at least one tagged broadcast header, and transmits the at least one tagged broadcast header to the originating receiving device.

13. The multi-node computing system of claim 12, wherein the switching device is a scalability port switch.

14. The multi-node computing system of claim 12, wherein the switching device is integrated into a scalability controller.

15. The multi-node computing system of claim 12, wherein the switching device is integrated into a processor device.

16. The multi-node computing system of claim 12, wherein the originating node is a processor node, and the broadcast transaction is selected from a group of a purge translation cache broadcast transaction, an interrupt broadcast transaction, an end interrupt broadcast transaction, a lock broadcast transaction, an unlock broadcast transaction, and an explicit writeback broadcast transaction.

17. The multi-node computing system of claim 12, wherein the switching device further includes a bypass device, wherein the bypass device receives the broadcast header from the originating receiving device, transmits the broadcast header to the primary tagging device, receives the at least one tagged broadcast header from the primary tagging device, and transmits the at least one tagged broadcast header to the originating receiving device.

18. The multi-node computing system of claim 17, wherein the switching device further includes a connecting device, wherein the originating receiving device receives the at least one tagged broadcast header from the bypass device, transmits at least one tagged broadcast transaction to the connecting device, and the connecting device transmits the at least one tagged broadcast transaction to at least one broadcast receiving device of the plurality of receiving devices.

19. The multi-node computing system of claim 18, wherein the at least one broadcast receiving device of the plurality of receiving devices receives the at least one tagged broadcast transaction, transmits the at least one tagged broadcast transaction to at least one broadcast node of the plurality of nodes, and the at least one broadcast node receives the at least one tagged broadcast transaction.

20. The multi-node computing system of claim 19, wherein the originating node may be one of the at least one broadcast node of the plurality of nodes.

21. The multi-node computing system of claim 19, wherein the at least one broadcast node completes an action requested by the at least one broadcast transaction, and transmits at least one node completion signal to the at least one broadcast receiving device of the plurality of receiving devices.

22. The multi-node computing system of claim 21, wherein the at least one broadcast receiving device transmits the at least one node completion signal to the bypass device and the bypass device transmits the at least one node completion signal to the primary tagging device.

23. The multi-node computing system of claim 21, wherein the primary tagging device, upon receipt of all of the at least one node completion signal from the at least one broadcast node through the at least one broadcast receiving device and the bypass device, transmits a transaction completion signal to the bypass device, the bypass device transmits the transaction completion signal to the originating receiving device, and the originating receiving device transmits the transaction completion signal to the originating node.

24. A method of broadcasting transactions, comprising:
receiving a broadcast transaction request at an originating receiving device of a switching device, wherein the switching device has a plurality of receiving devices;
decoding the broadcast transaction request and transmitting a broadcast header to a primary tagging device; and
generating at least one tagged broadcast header based on the broadcast transaction request, and transmitting the at least one tagged broadcast header to the originating receiving device.

25. The method of claim 24, further including receiving the broadcast header from the originating receiving device by a bypass device, transmitting the broadcast header to the primary tagging device, receiving the at least one tagged broadcast header from the primary tagging device and transmitting the at least one tagged broadcast header to the originating receiving device.

26. The method of claim 25, further including receiving the at least one tagged broadcast header and transmitting at least one tagged broadcast transaction from the originating receiving device to at least one broadcast receiving device of the plurality of receiving devices, wherein the at least one broadcast receiving device data is identified in a tagged broadcast header portion of the at least one tagged broadcast transaction.

27. The method of claim 26, further including receiving the at least one tagged broadcast transaction at a connection device from the originating receiving device, and transmitting the at least one tagged broadcast transaction to the at least one broadcast receiving device.

28. The method of claim 27, further including receiving the at least one tagged broadcast transaction at the at least one broadcast receiving device, transmitting the at least one tagged broadcast transaction to at least one broadcast node of a plurality of nodes of a multi-node computing system, and receiving the at least one tagged broadcast transaction at the least one broadcast node.

29. The method of claim 28, further including completing an action requested by the at least one tagged broadcast transaction, and transmitting at least one node completion signal to the at least one broadcast receiving device of the plurality of receiving devices.

30. The method of claim 29, further including transmitting the at least one node completion signal from the at least one broadcast receiving device to the primary tagging device through the bypass device.

31. The method of claim 30, further including receiving all of the at least one node completion signal from the bypass device, and transmitting a transaction completion signal to the originating receiving device through the bypass device.

32. A program code storage device, comprising:
a machine-readable storage medium; and
machine-readable program code, stored on the machine-readable storage medium, the machine readable program code having instructions to:
receive a broadcast transaction request at a originating receiving device of a switching device, wherein the switching device has a plurality of receiving devices;
decode the broadcast transaction request and transmit a broadcast header to a primary tagging device; and
generate at least one tagged broadcast header based on the broadcast transaction request, and transmit the at least one tagged broadcast header to the originating receiving device.

33. The program code storage device of claim 32, further including instructions to receive the broadcast header from the originating receiving device to transmit the broadcast header to the primary tagging device, to receive the at least one tagged broadcast header from the primary tagging device, and to transmit the at least one tagged broadcast header to the originating receiving device.

34. The program code storage device of claim 33, further including instructions to receive the at least one tagged broadcast header and transmit at least one tagged broadcast transaction from the originating receiving device to at least one broadcast receiving device of the plurality of receiving devices, wherein the at least one broadcast receiving device data is identified in a tagged broadcast header portion of the at least one tagged broadcast transaction.

35. The program code storage device of claim 34, further including instructions to receive the at least one tagged broadcast transaction at a connection device from the originating receiving device, and to transmit the at least one tagged broadcast transaction to the at least one broadcast receiving device.

36. The program code storage device of claim 35, further including instructions to receive the at least one broadcast transaction at the at least one broadcast receiving device, to transmit the at least one broadcast transaction to at least one broadcast node of a plurality of nodes of the multi-node computing system, and to receive the at least one broadcast transaction at the least one broadcast node.

37. The program code storage device of claim 36, further including instructions to complete an action requested by the at least one tagged broadcast transaction, and to transmit at least one node completion signal to the at least one broadcast receiving -device of the plurality of receiving devices.

38. The program code storage device of claim 37, further including instructions to transmit the at least one node completion signal from the at least one broadcast receiving device to the primary tagging device through the bypass device.

39. The program code storage device of claim 38, further including instructions to receive all of the at least one node completion signal from the bypass device, and to transmit a transaction completion signal to the originating receiving device through the bypass device.
